(19) United States
(12) Patent Application Publication
(10) Pub. No.: US 2009/0083155 A1
(43) Pub. Date: Mar. 26, 2009

(54) Systems and Methods for Usage Measurement of Content Resources

(75) Inventors: Frederic Burgess TUDOR, Menlo Park, CA (US); Carsten BLECKEN, Mountain View, CA (US); Kevin NILSON, Mountain View, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Espereka, Inc., Menlo Park, CA (US)

(21) Appl. No.: 12/199,781

(22) Filed: Aug. 27, 2008

Related U.S. Application Data
(60) Provisional application No. 60/974,292, filed on Sep. 21, 2007.

(51) Int. Cl. G06Q 30/00; G06F 15/173

(52) U.S. Cl. 705/14; 709/224; 705/1

(57) ABSTRACT

Systems and methods are provided for an effective usage measurement of content resources in a hyperlinked environment such as the World Wide Web. In one embodiment, a content publisher is to include the usage monitoring hyperlink (“UMH”) in its published content so that access to the content resource generates a network based UMH resource request. The network based request contains sufficient information to identify the accessed content resource as well as the provider and publisher. The system and method can be used to reliably measure the number of accesses to a particular content resource, since the embedded UMH triggers a measurement request when the content resource is accessed.

### RELATED APPLICATIONS

The present application claims priority to a provisional U.S. Patent Application Ser. No. 60/974,292, filed Sep. 21, 2007, entitled “Usage Measurement of Content Resources Utilizing Hyperlink Tags,” the disclosure of which is hereby incorporated herein by reference.

### BACKGROUND

Communication networks, such as the Internet, can distribute various types of content resources, such as text, image, audio and/or video. There are some systems designed to manage the use of copyrighted electronic media.

For example, some websites require an end user to pay a fee to access a piece of information, such as a sound, an image or a video clip.

For example, U.S. Pat. No. 6,389,541 discloses a way to distribute digital content such as text, video, and music as part of a compressed and encrypted data file, or object. The content is inaccessible to a user until a payment or use authorization occurs.

For example, U.S. Pat. No. 7,035,427 discloses a method to search a network for embedded content and verify with a database whether the content has been licensed for on-line uses.

For example, U.S. Patent Publication No. 2002/0186887 discloses a method for monitoring Internet dissemination of files by automatically downloading files from various Internet sites, checking these files for the presence of embedded digital watermark data, and alerting the proprietor of watermarked files about the distribution of their properties. Digital watermarks carry control flags used to control viewing or playback depending on content classification.

For example, U.S. Patent Publication No. 2004/0051812 discloses a method to collect data in connection with the retrieval of a media file through using an embedded media player page to provide a media file identification message to a log server to identify the media file. The log server records that the media file has been selected for play back by a user in a log associated with the media file.

For example, European Patent Application Publication No. 1,365,309 discloses a method for tracking the usage of electronic content over a network via a content package that has content and an address of a designated network node. When the content is used at the end user node, tracking information describing the use of the content is generated at the end user node. The tracking information is sent from the end user node to the designated network node using the designated network node address.

### SUMMARY OF THE DESCRIPTION

Systems and methods are provided for an effective usage measurement of content resources in a hyperlinked environment such as the World Wide Web. Some embodiments are summarized in this section.

In one embodiment, a content publisher is to include the usage monitoring hyperlink (“UMH”) in its published content so that access to the content resource generates a network based UMH resource request. The network based request contains sufficient information to identify the accessed content resource as well as the provider and publisher. The system and method can be used to reliably measure the number of accesses to a particular content resource, since the embedded UMH triggers a measurement request when the content resource is accessed.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 illustrates a system to distribute content resources according to one embodiment.

FIG. 2 shows a method to receive content resources from content providers according to one embodiment.

FIG. 3 shows a method to provide content resources to content publishers according to one embodiment.

FIG. 4 shows a method to measure usage of content resources by the content publishers via tracking activities of the end users of the content publishers according to one embodiment.

FIG. 5 shows a method to measure usage of content resources according to one embodiment.

FIGS. 6-7 show user interfaces to receive content resources from content providers according to one embodiment.

FIG. 8 shows a user interface to display a summary of a generated usage monitoring hyperlink according to one embodiment.

FIG. 9 shows a user interface to present account activities of a user according to one embodiment.

FIGS. 10-11 show user interfaces to license content resources to content publishers according to one embodiment.

FIG. 12 shows a data processing system which can be used in various embodiments.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

At least one embodiment of the disclosure provides a system and method for effective usage measurement of content resources (e.g., an image, a video clip, a sound file, an article, etc.) in a hyperlinked environment such as the World Wide Web.

In one embodiment, a content provider owns a content resource; and the content publisher obtains a usage right (e.g., license) to the content resource for the purpose of presenting the content resource (e.g., in a web page) to the visitor who consumes the content resource (e.g., by visiting or viewing the web page of the content publisher). The content resource may be any type of content published on the World Wide Web, such as articles, images, multimedia, etc.

In one embodiment, according to a license agreement for using the content resource on the web site of the content publisher, the content publisher is to include a code, such as a usage monitoring hyperlink (“UMH”), in its published content. Access to the content resource thus generates a network based request, such as a UMH resource request generated according to the UMH included in the published content.

In one embodiment, the usage monitoring hyperlink (“UMH”) causes the network based request to contain sufficient information to identify the content resource as well as the content provider, and the content publisher and other parameters such as parameters to specify the size of the return image, to specify an advertisement image as a return image, to specify content pricing, etc. Thus, the usage (e.g., distribution, impression) of the content resource by the content publisher is monitored via the usage monitoring hyperlink (“UMH”).

In one embodiment, the content provider is compensated according to the usage of the content resource; and the content publisher is charged for the license of the content resource according to the usage of the content resource. In another embodiment, the content provider pays the content publisher according to the usage of the content resource to distribute the content.

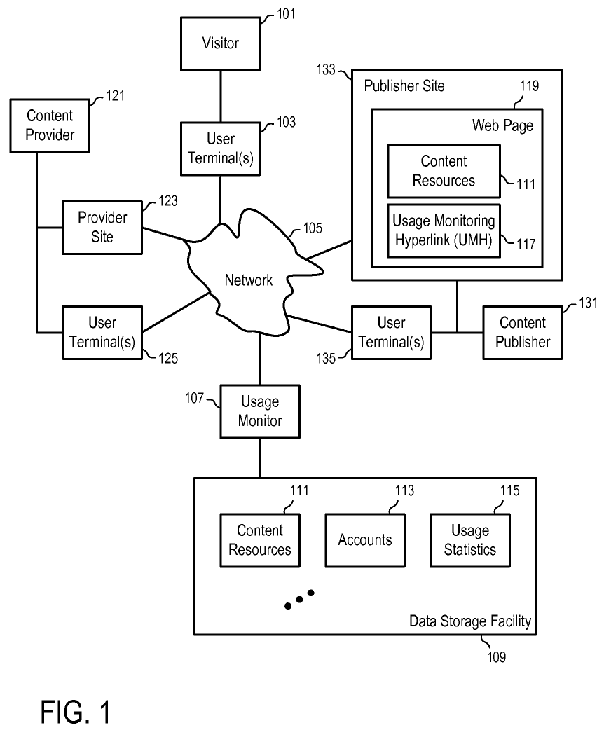

FIG. 1 illustrates a system to distribute content resources according to one embodiment. In FIG. 1, the content provider (121) uses the user terminal (125) to access the usage monitor (107) via the network (105), which may be a local area network, a wireless data communication network, a telephone network, a cellular communication network, a telecommunication network, a television network, an intranet, or a combination of networks, such as the Internet.

The content provider (121) may provide a content resource (111) to the data storage facility (109) for licensing to content publishers (e.g., 131). The content provider (121) may promote the content resource (111) on the provider site (123) which is typically under control of the content provider (121).

In FIG. 1, the content publisher (131) can use the user terminal (135) to access the usage monitor (107) to get a license for the content resource (111) of the content provider (121). A usage monitoring hyperlink (117) is generated and provided to the content publisher (131) to track the usage of the licensed content resources (111) on the publisher site (133), which is under control of the content publisher (131). For example, the content publisher (131) may license the content resource (111) for use in the web page (119) hosted on the publisher site (133).

In FIG. 1, the visitor (101) can use the user terminal (103) to access the web page (119) of the content publisher (131). When the web page (119) having the usage monitoring hyperlink (117) and the content resource (111) is loaded into the user terminal (103) for presentation to the visitor (101), the user terminal (103) generates a request to the usage monitor (107), which is configured to collect the usage statistics (115) on the data storage facility (109) based on the request received from the user terminal (103) via the usage monitoring hyperlink (117).

In one embodiment, the data storage facility (109) stores accounts (113) of the content providers (e.g., 121) and the content publishers (e.g., 131). The usage monitor (107) credits or charges the accounts (113) based on the usage statistics (115).

In one embodiment, the usage of the content resource (111) by the content publisher is measured based on the number of times the content resource (111) is distributed by the content publisher (131) via the publisher site (133), which corresponds to the number of times the content resource (111) is accessed by the visitor (101) or other end users of the content publisher (131). The usage monitor (107) is used to count the number of times the visitor (101) and other end users access the usage monitor (107) via the usage monitoring hyperlink (“UMH”) that is assigned to the content publisher (131) and thus determine the number of times the content resource (111) is distributed by the content publisher (131).

In one embodiment, the usage monitoring hyperlink (“UMH”) (117) is provided to the content publisher (131) for embedding in the publication that uses the content resource (111) that is provided by the content provider (121) and licensed by the content publisher (131). The usage monitoring hyperlink (“UMH”) (117) is arranged to coexist with the content resource (111) in the web page (119), or arranged to be in the same context as the content resource (111). The usage monitoring hyperlink (“UMH”) (117) may be a hyperlink content tag designed for tracking requests for the content resource (111).

In FIG. 1, when the content resource (111) in the publication of the content provider (131) is accessed by their visitors, the usage monitoring hyperlink (“UMH”) (117) causes the usage monitor (107) to be notified about the content resource usage. The usage monitor (107) may aggregate usage events for a comprehensive usage evaluation.

In response to a request generated according to the usage monitoring hyperlink (“UMH”) (117), the usage monitor (107) may provide a response, such as a usage monitoring hyperlink return resource (“UMH Return Resource”), which may be a transparent single pixel image, an advertisement, a script file, an empty script file, etc. In some embodiments, the usage monitor (107) does not provide a response.

In one embodiment, the usage monitor (107) is operated by an entity which is distinct and separate from the content provider (121) and the content publisher (131). The content provider (121) and the content publisher (131) may become registered users of the usage monitor (107) to have corresponding accounts (113) stored on the data storage facility (109). The content provider (121) provides the content resources (111); and the content publisher (131) uses the content resources in their publications.

In one embodiment, the data storage facility (109) stores the content resource (111). When the content publisher (131) obtains a license for the content resource (111) from the usage monitor (107), the content publisher (131) may download the content resource (111) from the data storage facility (109). Alternatively, the data storage facility may include a link to the provider site (123) to allow the content publisher to download the content resource (111) from the provider site (123).

In one embodiment, the license allows the content publisher (131) to use the content resource (111) in the web page (119) with or without modification. For example, the content publisher (131) may customize the content resource (111) for the web page (119). For example, the content publisher (131) may use a portion of the content resource (111), or insert additional content into the content resource (111), or modify one or more aspects of the content resource (111).

Since the embedded usage monitoring hyperlink (“UMH”) (117) (e.g., the UMH 117 that coexists with the content resources 111 in the web page 119, or the UMH 117 that is in the same context as the content resources 111 used in the web page 119 ) triggers a measurement request when the content resource (111) is accessed on the web page (119), the usage monitor (107) can reliably measure the number of accesses to the particular content resource (111) and thus compensate the content provider (121) or charge the content publisher (131) according to the actual usage of the content resource (111).

In a distributed content medium, such as the World Wide Web, it is generally difficult to determine the number of accesses to a particular content resource without access to software that facilitates the publication of the content resource (e.g. the web server). Storing usage information in the publication environment is possible but frequently not practical. To determine the number of accesses based on stored usage information in the publication environment, due to the lack of an appropriate publication environment for usage analysis, a large amount of access information might need to be transferred to another environment for usage analysis. Such an approach might cause a potential security breach. As a result, content publishers typically would not grant access to internal systems for analytic purposes.

The system illustrated in FIG. 1 provides a less complicated and much preferred approach in monitoring content usage by the content publishers. In FIG. 1, an end user, such as a visitor (101), accesses the content resource (111) in the web page (119) and thus causes the generation of a notification about the access event to a usage monitor (107), which is a central usage aggregation analysis environment outside of the environment of the content publisher (131 ). Such an approach eliminates the complexities of event aggregation for the content publisher (131) and allows the content publisher (131) to focus on publishing the content resource (111) for its visitors (e.g., 101) and not on an additional system for tracking content usage.

In one embodiment, to generate the notification the usage monitoring hyperlink (“UMH”) (117) uses the same mechanism to access the usage monitoring hyperlink return resource (“UMH Return Resource”) as the original request for the web page (119) that contains the content resource (111). This approach removes from the content publisher (131) the additional burden on the content publisher (131) for unnecessary involvement required in other approaches.

In one embodiment, when the visitor (101) accesses the publisher site (133) to request the content resource, this same action by the visitor (101) triggers a concurrent usage monitoring hyperlink (“UMH”) request to the usage monitor (107), which then identifies the requested content resource and delivers a usage monitoring hyperlink return resource (“UMH Return Resource”). In one embodiment, the usage monitor (107) counts the total usage as the aggregate sum of specific content resource requests over a defined time period, which corresponds to the aggregates sum of distributions of the content resource made by the content publisher.

In one embodiment, to facilitate the mechanism of usage monitoring, the usage monitor (107) generates a corresponding, unique usage monitoring hyperlink (“UMH”) (117) specifically for the content resource (111) and provide the content publisher (131) with the content resource (111), under a license from the content provider, along with the usage monitoring hyperlink (“UMH”) (117) for embedding in web publications of the content publisher (131) that use the content resource (111).

In one embodiment, the usage monitor (107) provides the content resource (111) and the usage monitoring hyperlink (117) to the content publisher (131) as separate usable components, such that the content publisher (131) may edit, customize or modify the content resource (111) for the web page independently from the usage monitor hyperlink (117). According to the license for the content resource (111), the content publisher (131) is obligated to place the user monitor hyperlink (117) on the same page (e.g., in the same HTML document) that uses the licensed content resource (111).

In one embodiment, the content publisher (131) is provided with a perpetual license to use the content resource (111) for web publication; and the license fee for the perpetual license is based at least in part on the usage of the content resource in the form of the number of copies of the content resources (111) distributed by the content publisher (131).

In one embodiment, the content provider (121) owns the content resource (111) and commercially offers the content resource (111) on a pay-per-view license basis to content publishers (e.g., 131) in a distributed environment such as the World Wide Web.

For example, the content provider (121) may have images as the content resources (111), which may be used on the publisher site (133) of the content publisher (131). With help from the usage monitor (107) the content provider (121) does not have to get involved in the licensing and tracking process involved in the publication of the content resource (111). The usage monitor (107) measures the usage of the content resource (111) so that the content provider (121) can maximize monetary compensation based on the usage of the content resource (111) by the content publisher (131). Through the usage monitor (107) the content provider (121) can easily license the content resource (111) to a large number of content publishers (e.g., 131).

Without a system as illustrated in FIG. 1, the usage measurement can become complicated, especially when the content provider (121) wants to license the content resource (111) to a large number of content publishers (e.g., 131). Without a system as illustrated in FIG. 1, the content provider may take a single and perpetual license fee associated with the content resource and thus throw away compensation opportunity by neglecting to take usage into account. Without a system as illustrated in FIG. 1, each content publisher (e.g., 131) may alternatively need a usage analysis utility that the content publisher has to put behind its firewall, which would put an undue burden on the content publisher and cause adoption of the system to fail.

In a distributed monitoring system as illustrated in FIG. 1, an access to the content resource (111) results in a notification to the central usage monitor (107) to track the usage of the content resource (111) in a distributed environment.

One of the benefits of setting up the usage monitor (107) using a standard-based method for accessing content resources (111) is that that it makes the least amount of demands on the content publisher (131). In one embodiment, means by which the content resource (111) is accessed on the World Wide Web is deployed for the purpose of monitoring content resource usage.

For example, the World Wide Web environment provides a construct called the hyperlink which can be used as a usage monitoring hyperlink (“UMH”) to monitor content resource usage. The usage monitoring hyperlink may contain information for usage tracking such as the access information (the web address) and some additional information about a specific content resource (111) not available in the meta data of the content resource itself.

In FIG. 1, when a visitor (101) accesses a hyperlink to request a web page (119) using the user terminal (103), the action by the visitor (101) results in the retrieval of the content resource (111) from the publisher site (133) according to the web address in the hyperlink pointing to the web page (119). Since both the content resource (111) and the unique usage monitoring hyperlink (117) are embedded in the web page (119), the visit to the web page (119) not only retrieves the content resource (111) itself but also sends an additional request for a usage monitoring hyperlink return resource to the web address of the usage monitor (107). The usage monitor (107) then uses the request as the notification of an instance of the usage of the content resource (111).

A usage monitoring hyperlink may be co-located with, or is a part of, the original content resource hyperlink to enable monitoring notifications. It may also be called a content tag.

In one embodiment, the content provider (121) provides the content resource (111) to the usage monitor (107) for storage in the data storage facility (109). The usage monitor (107) offers to content publishers (e.g., 131) the opportunity to obtain licenses for the content resource (111). When the content publisher (131) obtains a license from the usage monitor (107) for the content resource (111), the usage monitor (107) provides the content resources (111) with the usage monitoring hyperlink (117) to the content publisher (131), together with instructions for the content publisher (131) to place the usage monitoring hyperlink (117) where the content resource (111) is used (e.g., in the web page 119).

In one embodiment, the content provider (121) creates a usage monitoring hyperlink (117) for the content resource (111) and provides both the content resource hyperlink and the usage monitoring hyperlink (117) to the content publisher (131) for embedding in the web page (119). The content provider (121) may create the usage monitoring hyperlink (117) via the usage monitor (107), or create the usage monitoring hyperlink (117) and notify the usage monitor (107) of the usage monitoring hyperlink (117).

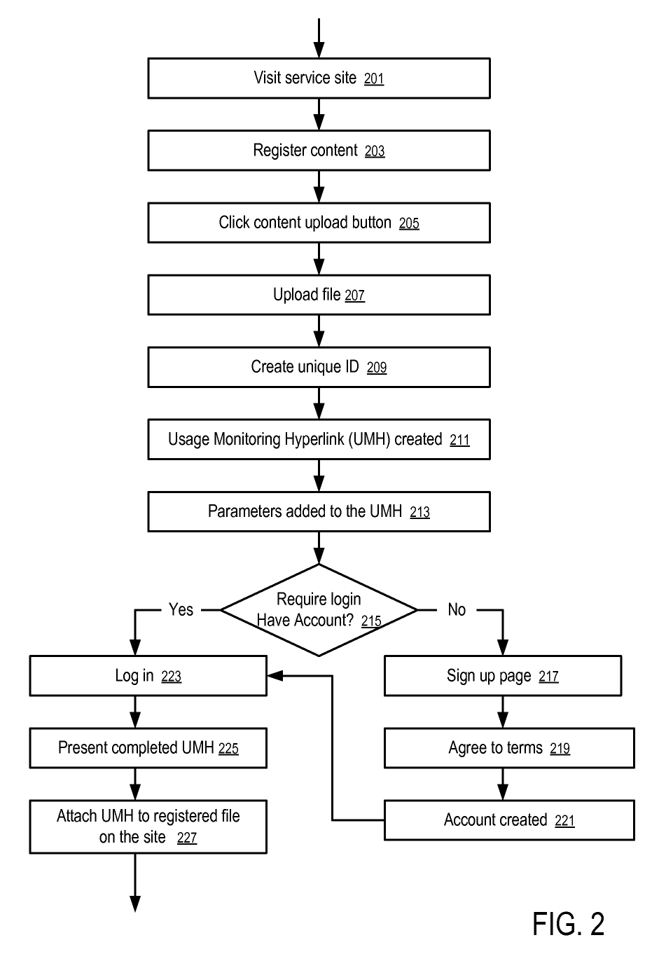

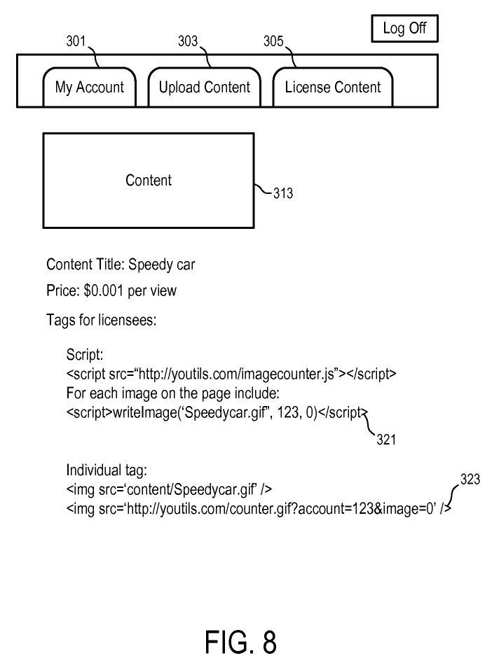

FIG. 2 shows a method to receive content resources from content providers according to one embodiment; and FIGS. 6-7 show user interfaces to receive content resources from content providers according to one embodiment.

In FIG. 2, the content provider (121) visits (201) the service site of the usage monitor (107) using the user terminal (125) and selects the option to register (203) content. The service site provides the content provider (121) with a user interface to upload the content (111) to the data storage facility (109), as illustrated in FIG. 6.

In FIG. 6, the content provider (121) may select the upload content tab (303) to upload a content resource (111) using the upload button (311). For example, the content provider (121) may specify the location of the content resource in the input box (307), or via selecting a browse button (309) to request a user interface to browse the file system to locate the content resource (111) in the user terminal (125) of the content provider (121).

After the content provider (121) clicks (205) the content upload button (311) in the user interface, the user terminal (125) uploads (207) the file that contains the content resource (111) to the data storage facility (109). FIG. 7 illustrates a user interface which presents the uploaded content resource (111) in the display area (313) and provides text input areas (317 and 315) to allow the content provider (121) to name the content and to provide a brief description of the content. In FIG. 7, the content provider (121) can create a tracking package (e.g., UMH 117) by selecting the create button (319).

The usage monitor (107) then creates (209) a unique ID to represent the content resource (111) and creates (211) a usage monitoring link (211). To add (213) parameters to the usage monitoring link (211), the usage monitor (107) determines (215) whether the content provider (121) has an account with the usage monitor (107) and if so whether the content provider (121) has logged in. In one embodiment, a usage monitoring link (211) is not issued until the provider (121) signs in. In another embodiment, a usage monitoring link (211) may be issued without some parameters; and these parameters can be added after the provider (121) signs in. In some embodiments, a usage monitoring link (211) is not linked to the account (113) of the provider (121) until the provider (121) signs in. The usage monitor (107) may associate additional parameters with a usage monitoring link (211) after its creation without changing the usage monitoring link (211) that is to be embedded in the web page (119). In some embodiments, the content provider (121) and/or the content publisher (131) may modify a usage monitoring link (211) via the usage monitor (107) (e.g., to associate the usage monitoring hyperlink (UMH) 117 used in the web page 119 with the account 113 of the content publisher 131).

If the content provider (121) does not have an account, a sign up page (217) is presented to the content provider. After the content provider agrees (219) to the terms of the services of the usage monitor (107), the usage monitor (107) creates (221) an account (113) for the content provider (121). In some embodiment, a separate service is provided to create and maintain the accounts (113).

After the content provider (121) logs (223) into the account (113) of the content provider (121), the usage monitor (107) can present (225) to the content provider (121) the completed usage monitoring hyperlink that has a parameter that represent the account (113) of the content provider (121) and attach (227) the usage monitoring hyperlink to the register file that contains the content resource (111).

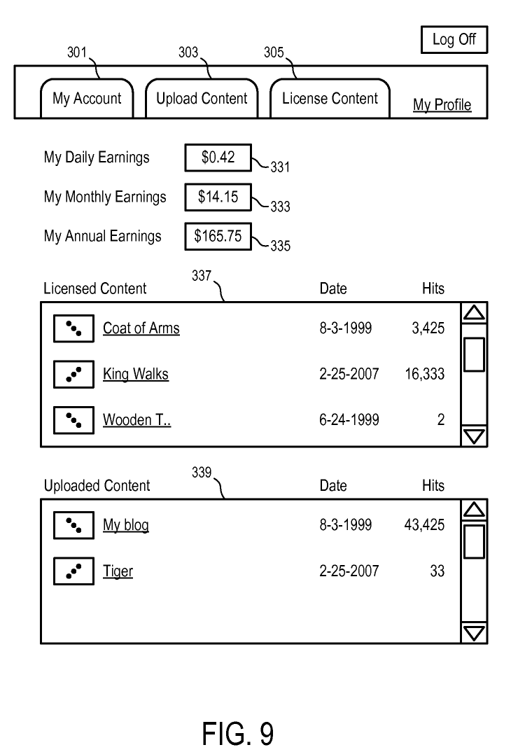

FIG. 8 shows a user interface to display a summary of the generated usage monitoring hyperlink according to one embodiment. In FIG. 8, the summary presents the content resource (111) in display area (313) and provides a script-based usage monitoring hyperlink (321) or an image tag-based usage monitoring hyperlink (323). The content provider (121) may provide instructions to licensees to embed one of the usage monitoring hyperlinks (321, 323) in a page for the licensed content resource (111) used in the page. In some embodiments, licensees obtain licenses via the usage monitor (107); and the usage monitor (107) provides instructions to licensees on requirements of using the usage monitoring hyperlinks (321, 323).

In some embodiments, the content provider (121) is provided with a “license me” link, which refers potential licensees to the usage monitor (107) to obtain licenses and usage monitoring hyperlinks and instructions for using the usage monitoring hyperlinks.

In some scenarios, the content provider (121) logs (223) in the account (113) of the content provider (121) before uploading the file that contains the content resource (111).

In some embodiments, the content provider (121) hosts the content resource (111) on the provider site (123) and provides to the usage monitor (107) a link to the content resource (111) to allow the content publisher (131) to obtain a licensed copy of the content resource (111) from the provider site (123). Thus, the usage monitor (107) does not have to host the content resources (111) on the data storage facility (109) for licensing the content resources (111) to the content publishers (e.g., 131).

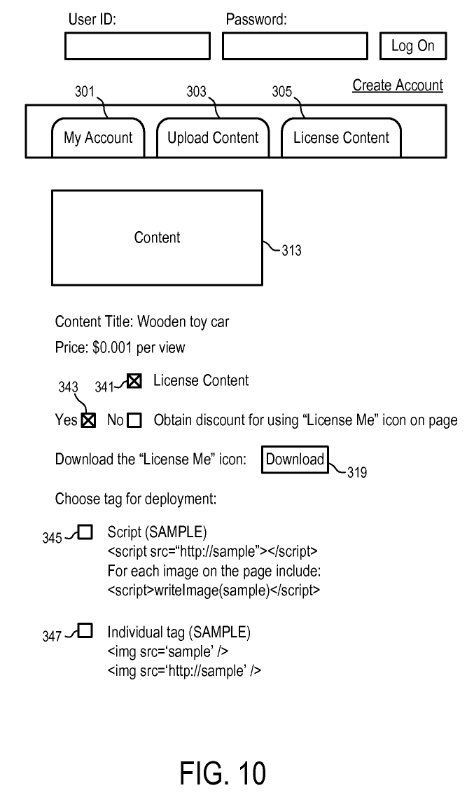

FIG. 9 shows a user interface to present account activities of a user according to one embodiment. Other user interfaces can also be used. In FIG. 9, after the user selects the “My Account” tab (301), account activities of the user are presented.

In FIG. 9, since the user is a content provider who owns a number of content resources that are licensed to other content publishes, the user interface illustrated in FIG. 9 shows the earnings (331, 333, 335) in various time periods (e.g., daily earnings, monthly earnings, annual earnings). The statistics of usages of the content resources owned by the user are presented in the display area (339).

In FIG. 9, since the user is also a content publisher who licenses content resources from other content providers, the user interface illustrated in FIG. 9 also shows the statistics of usages of the content resources the user licensed from other content providers in the display area (337).

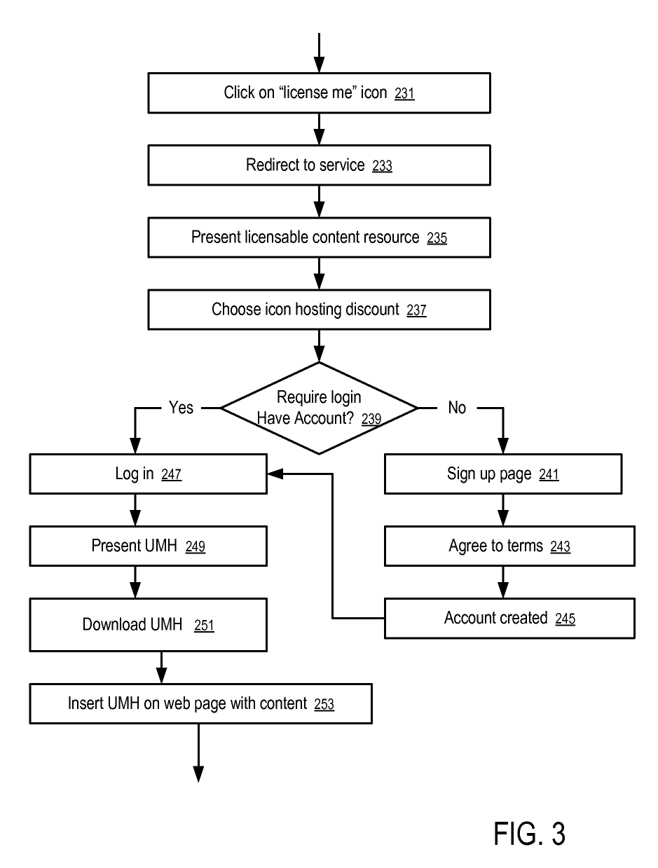

FIG. 3 shows a method to provide content resources to content publishers according to one embodiment. In FIG. 3, a content publisher (131) clicks on a “license me” icon associated with the content resource (111) of the content provider (121). The “license me” icon may be selected from on the provider site (123) near where the content resource (111) is presented. Or, the “license me” icon may be selected from the usage monitor (107) where the content resource (111) is promoted or listed for licensing. Or, the “license me” icon may be selected from other content publishers who have already licensed the content resources (111) and used the content resource (111) in their web publications.

In FIG. 3, after the content publisher (131) clicks on the “license me” icon, the hyperlink embedded in the icon directs (233) the content publisher (131) to the license service on the usage monitor (107), which presents (235) the licensable content resource (111) to the content publisher (131) with options for the content publisher (131) to host “license me” icon for a discount on the license fees. In some embodiments, the “license me” icon is presented at the same time the UMH is presented (249).

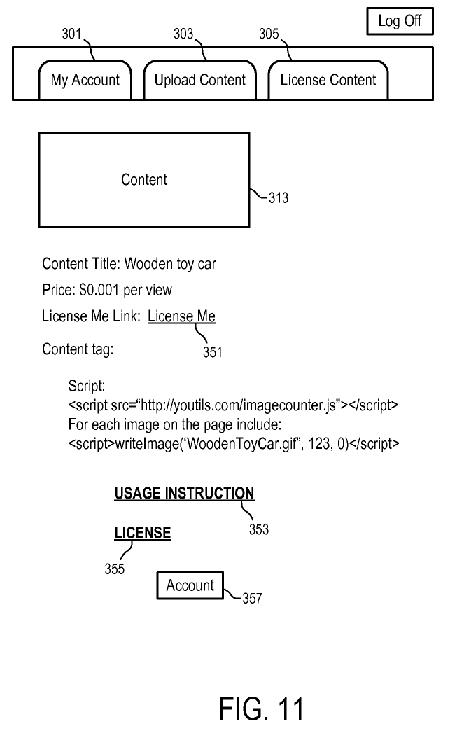

FIG. 10 illustrates a user interface to allow a content provider (131) to select options in obtaining a license according to one embodiment. In the license content tab (305) of FIG. 10, the content provider (131) may view the content resource (111) in the display area (313), select the option (341) to license the content resource (111), and select the “yes” option (343) to obtain a discount in licensing fee for hosting a “license me” icon on the page where the content resource (111) is used. When selected the “license me” directs the visitor (101) of the page to the usage monitor (107) to obtain a license for the content resource (111). If the content provider (131) chooses the “yes” option (343), the content provider (131) can select the download button (319) to obtain the “license me” icon. In some embodiments, the licensee is required by the license to present the “license me” icon where the license content resource (111) is used; and the user interface may not show the option (e.g., 343) for hosting “License Me” icon for discount.

In FIG. 10, the content provider (131) is provided with multiple options for a usage monitoring hyperlink. For example, the content provider (131) may select the option (345) to request the script-based usage monitoring hyperlink, or select the option (347) to request the image based on usage monitoring hyperlink. In one embodiment, a script provides both the usage monitoring hyperlink and the content resource.

In FIG. 3, to request a license of the content resource (111), the content publisher (131) is required to have an account with the usage monitor (107).

If it is determined (239) the content publisher (131) does not have an account, the usage monitor (107) (or a separate service) presents a sign up page (241) to ask the content publisher (243) to agree to terms of the services of the usage monitor (107). After the content publisher (243) agrees (243) to the terms, the usage monitor (107) creates (245) an account (113) for the content publisher (131).

After the content publisher (131) logs (247) into the account (113) of the content publisher (131) and agrees to the terms of the license of the content resource (111), the usage monitor (107) presents the usage monitoring hyperlink (117) to the content publisher (131) to allow the content publisher (131) to download (251) or copy the usage monitoring hyperlink (117) along with the content resource (111).

FIG. 11 illustrates a user interface to present the license and the usage monitoring hyperlink (117) to the content publisher (131) according to one embodiment. In FIG. 11, a “license me” link (351) is presented to the content publisher (131) who can copy the link (351) to the web page to host the “license me” link (351) for a discount on the licensing fees. In some embodiments, hosting the “license me” link (351) is required by the license; and copying the link (351) to the web page that uses the licensed content resource is mandatory. The user interface displays the usage monitoring hyperlink (117) of a type selected by the content provider (e.g., the script-based usage monitoring hyperlink in FIG. 11). The usage monitoring hyperlink (117) identifies the account (113) of the content publisher (131) and the licensed content resource (111). The content provider can select the link (353) for the instruction on the usage of the usage monitoring hyperlink, or select the link (355) for a copy of the license, or select the button (357) to view the account (113) of the content publisher (131).

The content publisher (131) can then use the licensed content resource (111) in a web page (119) and insert (253) the usage monitoring hyperlink (117) in the web page (119), according to the requirement of the license agreement, to allow the usage monitor (107) to track the usage of the content resource (111) by the content publisher (131).

In one embodiment, the content publisher (131) can insert the usage monitoring hyperlink (117) in the web page (119) as part of the web page (119) where the content resource (111) is used, without being limited to place the usage monitoring hyperlink (117) in the web page (119) in a particular way (e.g., at a location or in particular manner).

In one embodiment, the content publisher (131) may use the content resource (111) in the original form as obtained from the content provider (121) (e.g., obtained via the data storage facility 109 or via the provider site 123). In another embodiment, the content publisher (131) may customize the content resource (111) for the web page (119) and use the customized version of the content resource (111) in the web page (119). For example, the content publisher (131) may change the file format of the content resource (111), resize the content resource (111), use a portion of the content resource (111), or modify the content resource (111) to generate a derived version of the content resource (111).

In one embodiment, the content resource (111) is used by the content publisher (131) when a version of the content resource (111) is distributed by the content publisher (131). When the content resource (111) is used by the content publisher (131), the content publisher does not have to issue a usage monitor notification to the usage monitor (107). Rather, a visitor (101) that accesses the web page (119), owned by the content publisher (131), which uses the content resource, causing the usage monitor (107) to be activated due to the content monitoring hyperlink included in the web page (119). The visitor (101), and not the content publisher (131), therefore triggers the operations of the usage monitor (107) to count the usage of the content resource (111) by the content publisher (131).

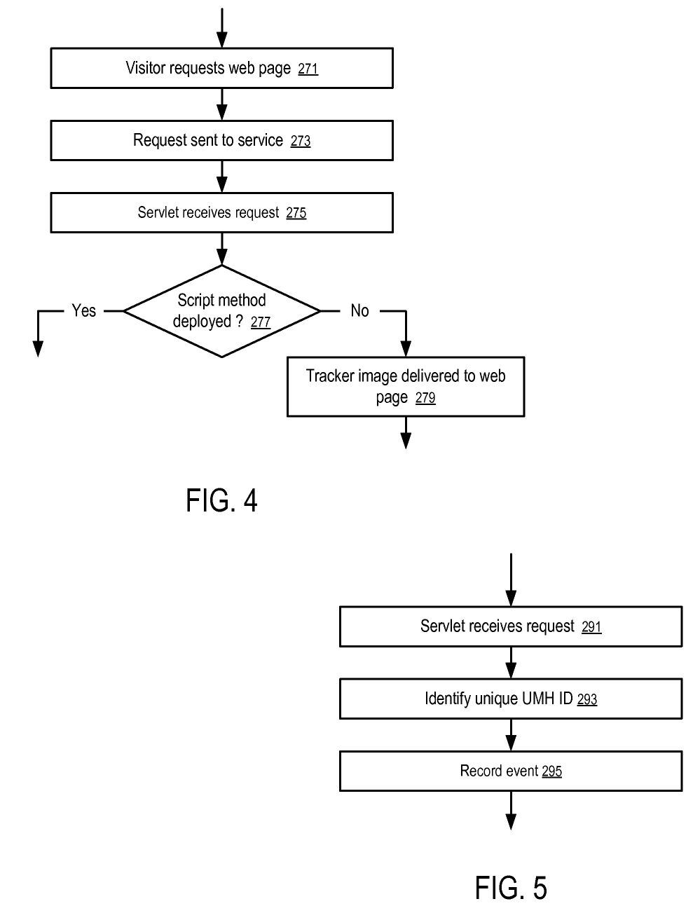

FIG. 4 shows a method to measure usage of content resources by the content publishers via tracking activities of the end users of the content publishers according to one embodiment.

In FIG. 4, a visitor (101) uses a user terminal (103) to request (271) a web page (119) published by the content publisher (131). The web page (119) includes a content resource (111) and a usage monitoring hyperlink (117). When the user terminal (103) presents the web page (119) to the visitor (101), the user terminal (103) sends (273) a request to the usage monitor (107) for the service of usage monitoring.

In one embodiment, a servlet implemented on the usage monitor (107) receives the request from the user terminal (103) when the web page (119) having the usage monitoring hyperlink (117) is rendered in the user terminal (103). The usage monitor (107) determines (277) whether a script method is deployed.

In one embodiment, when a script method is deployed, the usage monitor (107) counts the request without having to provide a response to the request. When the request is not based on a script method, the usage monitor (107) delivers (279) a tracker image to the web page that is rendered in the user terminal (103) as a response to the request received from the user terminal (103). In one embodiment, the tracker image is a transparent single pixel image.

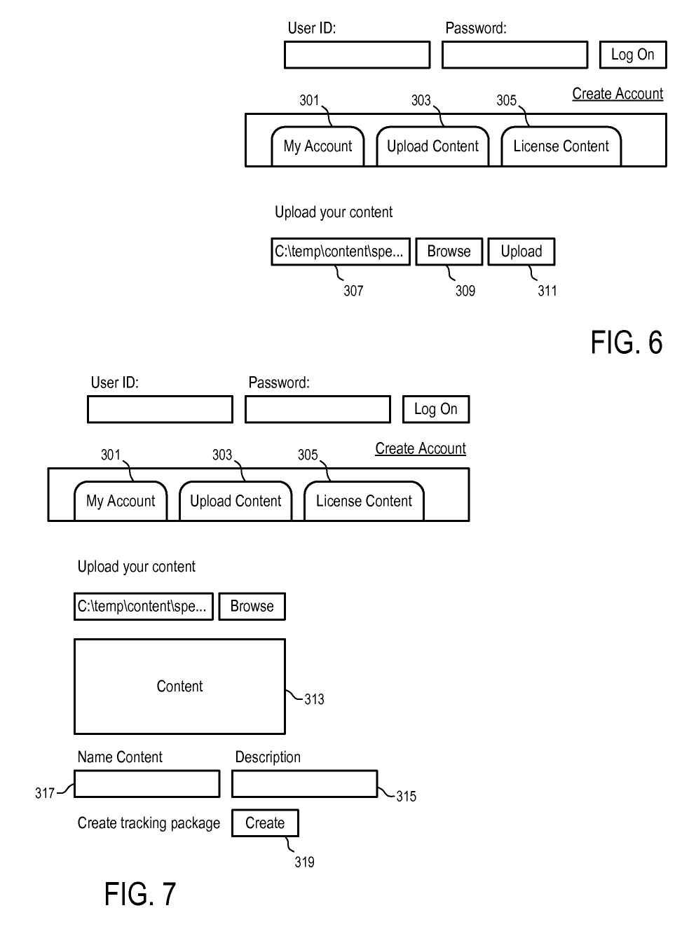

FIG. 5 shows a method to measure usage of content resources according to one embodiment. In FIG. 5, after the servlet running on the usage monitor (107) receives (291) the request from the usage monitor (107), the usage monitor (107) identifies the unique usage monitoring hyperlink (117) ID from the request. The unique usage monitoring hyperlink (117) ID identifies the content publisher (131) and the content resource (111). The usage monitor (107) thus records the event (295) in the data storage facility (109) to generate the usage statistics (115).

The additional notification caused by the usage monitoring hyperlink (117) requires time and network transfers for execution (page load) than without the usage monitoring hyperlink (117). In one embodiment, to keep the notification request itself carry as little information as necessary a short but unique identifier used in the notification request to identify the content resource.

In one embodiment, to reduce the time and network transfer, a minimally sized UMH Return Resource is provided as a response to the notification request. For example, the usage monitor (107) may use a single pixel image or an empty script using a scripting language such as JavaScript.

In one embodiment, the content provider (121) or the usage monitor (107) can offer the content publisher (131) several different UMH content tags, from which one can be selected for deployment on a web page (119) with the corresponding content resource (111).

In one embodiment, the unique identifier embedded in the usage monitor hyperlink (117) is used for monitoring accesses to the content resource (111). The creation of an identifier is initiated by the content provider (121) by utilizing the content tag generation system of the usage monitor (107).

In one embodiment, after creating the usage monitoring hyperlink (117) corresponding to the content resource (111), the content provider (121) shares the knowledge about the identifier with the usage monitor (107). In one embodiment, the content tag generation system and the usage monitoring system use the same database to share the knowledge about the identifiers and to ensure that the UMH (117) content tag is correctly correlated with the content resource (111).

In one content usage scenario, the content provider (121) offers web content for syndication since it can be monitored by a third party. The content provider (121) provides sufficient information about the content resource (111), including the content resource (111) itself, to the content publisher (131). After a content tag, such as the UMH (117) is generated, the content publisher (131) publishes the UMH (117) with the content resource (111) on the same publishing unit, such as the web page (119). The content resource (111) can thereafter be consumed by the visitor (101) and monitored by the usage monitor (107) when the content resource (111) is distributed to the visitor (101). The visitor (101) consumes the content resource tag when the content resource (111) and corresponding UMH (117) is accessed, creating a usage monitor notification event.

The content publisher can stop the usage of the monitored content resource (111) by removing it from the publication site. In one embodiment, the content provider (121) may request the content publisher (131) to remove the content resource (111) from the web page (119).

In one embodiment, the usage monitor (107) is used as a web site facilitating the licensing of content between parties wishing to license content (e.g., content provider 121) and parties wishing to host content (e.g., content publisher 131). The content provider (121) is a party offering to license web content and be compensated on a per use basis. The content publisher (131) is a web content publisher intending to license the content from the content provider (121). The content publisher may be motivated by frequent accesses to the content, which may be useful to the publisher site (133), and will therefore willingly pay for the content by means of a license.

In one embodiment, a third party operates the web site of the usage monitor (107) to assist the two parties (e.g., the content provider 121 and the content publisher 131, which may be called seller and buyer respectively) in the licensing process. The third party proves the licensing framework, the content tag creation and/or usage monitoring.

In one embodiment, when the content publisher (131) selects a content resource (111) for his/her publication, such as the web page (119), he/she asks the usage monitor (107) to provide a unique usage Monitoring Hyperlink (“UMH”) that is associated with the content resource (111) in question. The usage monitor (107) produces a UMH that contains information that identifies the content publisher (131) and the content resource (111). Other information such as the type of content (e.g., image, movie, sound file, etc.) or metadata can also be contained in the UMH. The usage monitor (107) is configured to decode the UMH to identify information about the content resource (131) and its usage by the content publisher (131).

After the content publisher (131) obtains the unique UMH from the Usage Monitor (107), the content publisher (131) can then publish the content resource (111) along with the UMH on his/her website. In one embodiment, the UMH includes a link to a UMH return resource (111) hosted on the usage monitor. The UMH return resource (111) can be published in many forms. For example, a UMH Return Resource may be a small transparent image that is hosted by the Usage Monitor. When the content resource (111) embedded in the web page (119) is served to the user terminal (103) of the visitor (101), the UMH Return Resource, in the form of a small image, is also served from the usage monitor (107).

Serving the UMH Return Resource as a small transparent image has many advantages. For example, caching can be disabled to record all requests. Since the image is transparent and small, it does not interfere with the page layout. Accesses by spiders/robots/web crawlers (e.g., bots) can be excluded or eliminated from the usage statistics by checking user-agent of the HTTP (HyperText Transfer Protocol) requests. The small image has low bandwidth requirements. Adding images to a page is simple and well understood by web designers of content publishers.

The UMH Return Resource can also be published in the format of a regular image such as an icon for the “license me” link. Serving the UMH Return Resource as a regular image has many advantages. For example, caching can be disabled to record all requests. Accesses by spiders/robots/web crawlers (e.g., bots) can be excluded or eliminated from the usage statistics by checking user-agent of HTTP (HyperText Transfer Protocol) requests. Depending on image size the UMH return resource may use a low bandwidth. Adding images to a page is simple and well understood by web designers of content publishers and general publisher users such as those of social networking sites. Further, advertisements can be placed within the image provided as the UMH return resource. Advertisements can be placed on or next to the content resource as well. In one embodiment, the image provided as the UMH return resource prompts the view to obtain a license of the content resource; and the image is selectable to visit the usage monitor (107) to obtain a license for the content resource. For example, the image may include the word “license me” or “LicenzMe!”.

The UMH Return Resource can also be published in the format of a remote script (such as JavaScript). For example, the UMH (117) may point to the usage monitor (107) for a file of script that is to be retrieved to render the web page (119). Serving the UMH return resource as a remote script has many advantages. For example, caching can be disabled to record all requests. Accesses by spiders/robots/web crawlers (e.g., bots) can be excluded or eliminated from the usage statistics by checking user-agent of HTTP (HyperText Transfer Protocol) requests. Since the script may be empty and not delivered back to the UMH hosting page, such a method can have a very low bandwidth requirement. Adding script includes to a web page is simple and well understood by web designers of content publishers and general publisher users such as those of social networking sites. The script has no layout affect on the web page (119); and failures to provide the script do not cause the browser to display on screen an indication of an unavailable image or any errors.

The UMH Return Resource can also be published in the format of a response to a remote call/cross site scripting. For example, the UMH (117) may include a remote call to the usage monitor via a script. For example, for a licensed content resource (111) used the web page (119) of the content publisher, a JavaScript tag can be included as the UMH to an AJAX (Asynchronous JavaScript and XML) call to notify the usage monitor (107) of content request, rather than to deliver a single pixel image.

Serving the UMH Return Resource as a response to a remote call has many advantages. For example, such a method does not have caching issues, since remote calls cannot be cached. Accesses by spiders/robots/web crawlers (e.g., bots) can be excluded or eliminated from the usage statistics by checking user-agent of HTTP (HyperText Transfer Protocol) requests. The method uses low bandwidth; and call size can be minimized. Further, the scripts can be deployed as a JavaScript file downloaded from the usage monitor (107); and dynamic updates to the scripts may be made easily. Furthermore, failures to provide the script do not cause the browser to display on screen an indication of an unavailable image.

In FIG. 1, when the usage monitor (107) receives the UMH request, the UMH request is decoded to determine which account (113) and which content resource (111) are associated with request. The usage monitor (107) then records the usage information to generate the usage statistics (115) and returns the UMH return resource in some embodiments.

In FIG. 1, the usage monitor (107) accepts accesses, reads the UMH content tag and associates it with the content resource itself.

In one embodiment, the usage monitor (107) creates the UMH content tag and stores the associated information in a single database. Widely available relational database systems can be used to implement the data storage facility (109). The database is shared between the content tag creation module and the usage monitoring module of the usage monitor, using the same database used by the usage monitor (107). Visitor accesses will cause the delivery of the content tag to the usage monitor (107) and subsequent identification of the uniquely associated content resource (111) in the database on the data storage facility (109).

In one embodiment, a counter is stored in the database. The counter is associated with the content resource (111) and the account (113) of the content publisher (131) in the data storage facility (109). The counter may be created in response to a request generated according to the usage monitoring hyperlink (117) when the content resource (111) is first distributed by the content publisher (131). Alternatively, the counter can be created when the content publisher accepts the license for the content resource (111). Subsequent distributions by the content publisher (131) cause the usage monitor (107) to increment the counter (e.g., when the visitor 101 views the usage monitor hyperlink (UMH) 117 and the content resource 111 in the web page 119). In one embodiment, the usage monitor (107) does not increment the counter when the usage monitor hyperlink (UMH) (117) and the content resource (111) in the web page is viewed by the content publisher (131), or the content provider (121).

In one embodiment, the access request from the visitor (101), in the form of a UMH notification, is processed by the usage monitor (107) as efficient as possible, so that the visitor (101) does not experience a significant slowdown in access times. For example, the usage monitor (107) may collect some access events together in temporary memory, before an update of the count in the database occurs.

In one embodiment, the resource linked by the UMH is not to be cached; and all accesses to the resource linked by the UMH are treated the same. However, the content resource (111) may be cached.

In one embodiment, the usage monitor (107) differentiates a “bot” (or robots on the Internet that are automatically generate page activity based on information they search) from a qualified visitor (101) access request. In one embodiment, the usage monitor (107) accomplishes this by identifying the user agent identifier of the HTTP (HyperText Transfer Protocol) requests and/or the referrer hyperlink (URL).

In one embodiment, the web site offers a service to monitor content delivery (impression/usage) for content revenue generation in the web/mobile space. The web site provides a distributed system for exposing licensable content on the web, such as articles, blogs, poems, scientific dissertations, music, designs, images, video, code (calculators, programs, etc.) etc.

Since the usage monitor (107) tracks actual usage of content, the content provider (121) gets the opportunity of low cost methods for licensing content; and the content publisher (131) pays for only what is used (viewed), not for holding the content itself. The usage monitor (107) thus offers a licensing framework/a commercial framework and aggregates usage count.

To facilitate the operation of the usage monitor (107), the content publisher (131) inserts HTML (HyperText Markup Language) code in the web page (119) but does not have to install other software on their site (133).

In one embodiment, the usage monitor (107) includes a web site (e.g., youtils.com) which offers a central repository to allows content provider to upload content, generate a unique ID and link tag, and generate a “License Me” icon that links back to Youtils.com. The central repository allows content publisher to license content. Depending on the arrangement, the licensee may either pay or be paid for content use.

To use the service of the usage monitor (107), the content provider (121) creates an account (113) and agrees to the license, provides information about a financial account (e.g., credit card, PayPal, etc.) for credit or debit based on the monitored usage of the content resource (111). The content provider (121) submits the content resource (111) to the usage monitor (107) to generate Usage Monitoring Hyperlink (“UMH”) and “License Me” icon and appends UMH and “License Me” link to content on provider site (123).

To use the service of the usage monitor (107), the content publisher (131) may click on “License Me” icon to be directed to the licensing site of the usage monitor (107) (e.g., Youtils.com). The content publisher (131) creates an account by agreeing to a license and providing information about a financial account (e.g., credit card, PayPal, etc.). After taking a license for the content resource (111), the content publisher appends the UMH (117) (and “License Me” icon if desired) in the document that uses the relevant content resource (111).

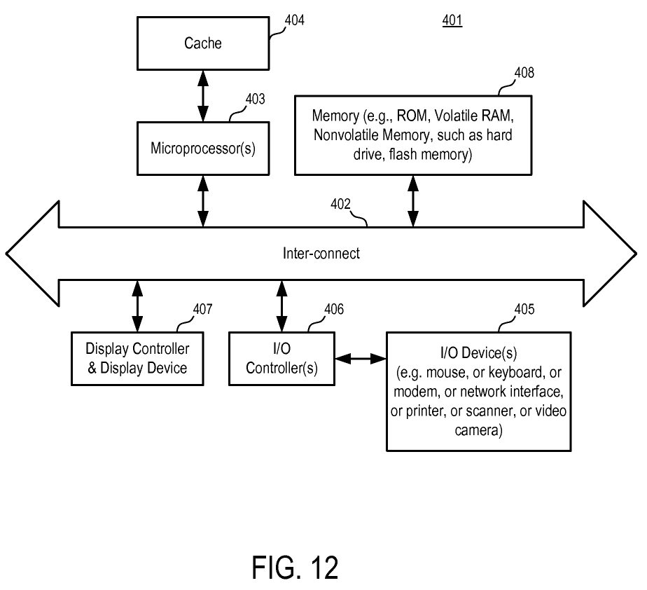

FIG. 12 illustrates a data processing system which can be used in various embodiments. While FIG. 12 illustrates various components of a computer system, it is not intended to represent any particular architecture or manner of interconnecting the components. Some embodiments may use other systems that have fewer or more components than those shown in FIG. 12.

In one embodiment, a server data processing system illustrated in FIG. 12 implements at least one of the components shown in FIG. 1, such as the provider site (123), the publisher site (133), the usage monitor (107), and/or the storage facility (109), etc. In some embodiments, one or more of the components shown in FIG. 1, such as the provider site (123), the publisher site (133), the usage monitor (107) may be implemented as web server(s), which may include the service of a peer to peer network of a plurality of data processing systems as illustrated in FIG. 12, or a network of distributed computing systems. In some embodiments, a server data processing system as illustrated in FIG. 12 may include a peer to peer network, or a distributed computing system.

In one embodiment, a user terminal (103, 125 or 135) is a data processing system as illustrated in FIG. 12.

In FIG. 12, the data processing system (401) includes an inter-connect (402) (e.g., bus and system core logic), which interconnects a microprocessor(s) (403) and memory (408). The microprocessor (403) is coupled to cache memory (404) in the example of FIG. 12.

The inter-connect (402) interconnects the microprocessor(s) (403) and the memory (408) together and also interconnects them to a display controller and display device (407) and to peripheral devices such as input/output (I/O) devices (405) through an input/output controller(s) (406). Typical I/O devices include mice, keyboards, modems, network interfaces, printers, scanners, video cameras and other devices which are well known in the art. In some embodiments, when the data processing system is a server system, some of the I/O devices, such as printer, scanner, mice, and/or keyboards, are optional.

The inter-connect (402) may include one or more buses connected to one another through various bridges, controllers and/or adapters. In one embodiment the I/O controller (406) includes a USB (Universal Serial Bus) adapter for controlling USB peripherals, and/or an IEEE-1394 bus adapter for controlling IEEE-1394 peripherals.

The memory (408) may include ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs”. The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The instructions may be embodied in digital and analog communication links for electrical, optical, acoustical or other forms of propagated signals, such as carrier waves, infrared signals, digital signals, etc.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method implemented in a data processing system, the method comprising:
providing to a content publisher a content resource and a code, the code identifying the content resource and the content publisher, the code to coexist with a version of the content resource in one or more documents published by the content publisher, when rendered for presentation in a browser the code to cause the browser to send a request to a server; and
the data processing system measuring usage of the content resource by the content publisher through receiving at the server one or more requests generated by the code.

2. The method of claim 1, further comprising:
presenting a user interface to offer a license to the content resource to the content publisher, wherein the content resource and the code are provided to the content publisher in response to the content publisher accepting the license.

3. The method of claim 2, further comprising:
compensating a content provider and charging the content publisher for the license based on the measured usage of the content resource.

4. The method of claim 3, further comprising:
receiving the content resource from the content provider and storing the content resource; and
providing a link to the license on the server to content provider.

5. The method of claim 2, wherein license fees for the content resource is based on the measured usage.

6. The method of claim 2, wherein the license comprises a perpetual license.

7. The method of claim 1, wherein the content resource comprises article, music, image, video, or code.

8. The method of claim 1, wherein the code comprises a link to an image on the server.

9. The method of claim 8, wherein the image is a single transparent pixel.

10. The method of claim 8, wherein the image is selectable to visit the server to obtain a license to the content resource from the server.

11. The method of claim 1, wherein the code is to include a script from the server or to cause a remote call to the server.

12. The method of claim 11, wherein the script provides the content resource.

13. The method of claim 1, wherein the code is separate from the content resource; and the version of the content resource in the one or more documents published by the content publisher is a modified version of the content resource.

14. The method of claim 1, wherein the code further comprises a link to the server, which link when selected causes the server to provide a user interface to offer a license to the content resource.

15. The method of claim 1, further comprising:
checking user agents of the requests to exclude from the measured usage requests generated by the code via bots.

16. The method of claim 1, further comprising:
providing one or more advertisements in response to the one or more requests.

17. The method of claim 1, wherein the measuring of the usage of the content resource by the content publisher comprises counting a number of times one or more versions of the content resource are accessed by end users of the content publisher.

18. The method of claim 1, further comprising:
identifying referrer hyperlinks of the one or more requests to exclude from the measured usage requests generated by bots using the code.

19. A machine readable media embodying instructions, the instruction causing a data processing system to perform a method, the method comprising:
providing to a content publisher a content resource and a code, the code identifying the content resource and the content publisher, the code to coexist with a version of the content resource in one or more documents published by the content publisher, when rendered for presentation in a browser the code to cause the browser to send a request to a server; and
the data processing system measuring usage of the content resource by the content publisher through receiving at the server one or more requests generated by the code.

20. A data processing system, comprising:
means for providing to a content publisher a content resource and a code, the code identifying the content resource and the content publisher, the code to coexist with a version of the content resource in one or more documents published by the content publisher, when rendered for presentation in a browser the code to cause the browser to send a request to a server; and
means for measuring usage of the content resource by the content publisher through receiving at the server one or more requests generated by the code.
